(19) United States
(12) Patent Application Publication
(10) Pub. No.: US 2005/0265429 A1
(43) Pub. Date: Dec. 1, 2005

(54) Transmitter and receiver for fast frequency for fast frequency hopping in an orthogonal frequency division multiplexing system

(75) Inventors: Yun-Ok Cho, Suwon-si (KR); Joon-Young Cho, Suwon-si (KR); Ju-Ho Lee, Suwon-si (KR); Peter Jung, Duisburg (DE); Thomas Faber, Duisburg (DE); Tobias Scholand, Duisburg (DE); Katzmarcos Daniel, Duisburg (DE); Guido Bruck, Duisburg (DE)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/103,808

(22) Filed: Apr. 12, 2005

(30) Foreign Application Priority Data
Apr. 12, 2004 (KR) 2004-25133

(51) Int. Cl. H04B 1/713

(52) U.S. Cl. 375/135; 375/136

(57) ABSTRACT

A transmitter and receiver for fast frequency hopping (FFH) of a sample time unit in an orthogonal frequency division multiplexing (OFDM) communication system. The transmitter includes an FFH frequency modulator for converting the data elements of the data vector into a transmission signal vector that hops to a frequency in a sample time unit according to an FFH pattern of the sample time unit. The receiver includes a Fast Fourier Transform (FFF) processor for transforming a received signal vector after frequency hopping into a second received signal vector of a frequency domain by using FFT, a first equalizer for multiplying the received signal vector by an inverse matrix of a channel matrix representing characteristics of a channel from the transmitter to the receiver, and a frequency hopping recovery unit for outputting a recovered received signal vector.

### PRIORITY

This application claims priority to an application entitled “TRANSMITTER AND RECEIVER FOR FAST FREQUENCY HOPPING IN AN ORTHOGONAL FREQUENCY DIVISION MULTIPLEXING SYSTEM”, filed in the Korean Intellectual Property Office on Apr. 12, 2004 and assigned Serial No. 2004-25133, the contents of which are incorporated herein by reference.

### BACKGROUND OF THE INVENTION

1. Field of the Invention

The present invention relates generally to an orthogonal frequency division multiplexing (OFDM) system, and more particularly to a transmitter and receiver for fast frequency hopping (FFH).

2. Description of the Related Art

An orthogonal frequency division multiplexing (OFDM) system transmits input data through a plurality of parallel carriers at a slow rate, such that the effect of inter-symbol interference (ISI) in a channel with frequency selective fading or multipath fading is reduced. When single-carrier transmission and multicarrier transmission are compared at the same data transmission rate, a symbol cycle for the multiple carriers increases in proportion to the number of carriers used. The OFDM system has better spectral efficiency because spectra of subchannels overlap each other while maintaining orthogonality.

In the OFDM system, a transmission signal is modulated through Inverse ast Fourier Transform (IFFT), and a received signal is demodulated through Fast Fourier Transform (FFT), such that a digital modulator and demodulator can be efficiently configured. This configuration is advantageous in that a receiver is easily configured by a 1-tap equalizer requiring a single complex multiplication because channel characteristics of each subchannel band are approximated in a regular or flat form within the subchannel band.

As one of multiple access schemes in an OFDM communication system, a frequency hopping (FH)-OFDM scheme performs FH in a subcarrier level. The FH scheme in the OFDM system transmits data while periodically changing a subcarrier or periodically performing the FH to prevent a user from continuously suffering deep fading according to frequency selective channel characteristics in the OFDM system for multiple users. In this case, an FH time unit is at least one symbol, and is conventionally one symbol duration. Because the FH scheme hops to a different subcarrier to transmit data for the next symbol time when data is transmitted at a subcarrier suffering the deep fading for a symbol time, it can obtain the frequency diversity effect and averages interference between different cells while preventing a user from consecutively suffering the deep fading.

A base station supporting an FH-OFDM communication function dynamically allocates subcarriers to symbols according to a unique FH pattern. The FH pattern is formed by FH sequences that are orthogonal to each other, such that neighboring base stations can simultaneously use orthogonal subcarriers without interference between cells. A terminal identifies different FH patterns of the base stations by detecting subcarriers including pilot samples.

To sufficiently obtain the FH effect, the conventional OFDM system must perform FH through many symbol durations, requires many users, and must select an appropriate hopping pattern according to channels. Accordingly, the conventional OFDM system can prevent a user from consecutively suffering the deep fading. However, there is a problem in that data of another user using a specific subcarrier suffering the deep fading is still damaged in each symbol time.

### SUMMARY OF THE INVENTION

Accordingly, the present invention has been designed to solve the above and other problems occurring in the prior art. Therefore, it is an aspect of the present invention to provide a transmitter and receiver for fast frequency hopping (FFH) in an orthogonal frequency division multiplexing (OFDM) communication system.

The above and other aspects of the present invention can be achieved by a transmitter for performing fast frequency hopping (FFH) in an orthogonal frequency division multiplexing (OFDM) communication system using a plurality of subcarriers. The transmitter includes: a serial-to-parallel (S/P) converter for converting an input data stream into a data vector formed by a plurality of data elements; an FFH frequency modulator for converting the data elements of the data vector into a transmission signal vector hopping to a frequency in a sample time unit according to an FFH pattern of the sample time unit; and a parallel-to-serial (P/S) converter for converting the transmission signal vector in a serial fashion to output a transmission signal.

Additionally, a receiver is provided for recovering transmitted data according to a fast frequency hopping (FFH) pattern of a sample time unit in an orthogonal frequency division multiplexing (OFDM) communication system using a plurality of subcarriers. The receiver includes: a serial-to-parallel (S/P) converter for receiving, from a transmitter, a signal hopped to a frequency according to the FFH pattern of the sample time unit, and converting the received signal into a first received signal vector formed by a plurality of data samples; a first Fast Fourier Transform (FFT) processor for transforming the first received signal vector into a second received signal vector of a frequency domain by using FFT; a first equalizer for multiplying the received signal vector by an inverse matrix of a channel matrix representing characteristics of a channel from the transmitter to the receiver; a frequency hopping recovery unit for outputting a received signal vector recovered from output of the first equalizer according to the FFH pattern of the transmitter; and a parallel-to-serial (P/S) converter for converting the recovered received signal vector in a serial fashion to output a data stream.

### BRIEF DESCRIPTION OF THE DRAWINGS

The above and other aspects and advantages of the present invention will be more clearly understood from the following detailed description taken in conjunction with the accompanying drawings, in which:

FIG. 1 is a schematic diagram illustrating a conventional multicarrier modulator;

FIG. 2 illustrates a relation between orthogonal frequency division multiplexing (OFDM) samples and an OFDM symbol;

FIG. 3 is a block diagram illustrating a conventional transmitter and receiver of an OFDM communication system;

FIGS. 4A to 4E are schematic diagrams illustrating examples of multicarrier modulators where M=4;

FIGS. 5A and 5B are conceptual diagrams illustrating vector signal models representing multicarrier modulation in an OFDM system and a fast frequency hopping (FFH)/OFDM system;

FIG. 6 is a block diagram illustrating a transmitter of an FFH/OFDM communication system in accordance with a preferred embodiment of the present invention;

FIG. 7 is a block diagram illustrating a transmitter of an FFH/OFDM communication system in accordance with another preferred embodiment of the present invention; and

FIG. 8 is a block diagram illustrating a receiver of an FFH/OFDM communication system in accordance with a preferred embodiment of the present invention.

### DETAILED DESCRIPTION OF THE PREFERRED EMBODIMENTS

Preferred embodiments of the present invention will be described in detail herein below with reference to the accompanying drawings. In the following description, a detailed description of known functions and configurations incorporated herein will be omitted for conciseness. It is to be understood that the phraseology and terminology used herein are for the purpose of description and should not be regarded as limiting.

The present invention is directed to a system and method for performing fast frequency hopping (FFH) on the basis of a multiple of an orthogonal frequency division multiplexing (OFDM) sample time in an OFDM communication system. The present invention is applied to the OFDM communication system for transmitting data using multiple carriers. To perform FH in a sample time unit, differently from the conventional OFDM communication system for performing frequency hopping (FH) in a symbol time unit, transmitting and receiving sides must map OFDM samples of subchannels to subcarriers according to a predetermined pattern before mapping the OFDM samples to one OFDM symbol. Accordingly, the specification of the present invention describes devices necessary for the FH of samples and operation of the devices.

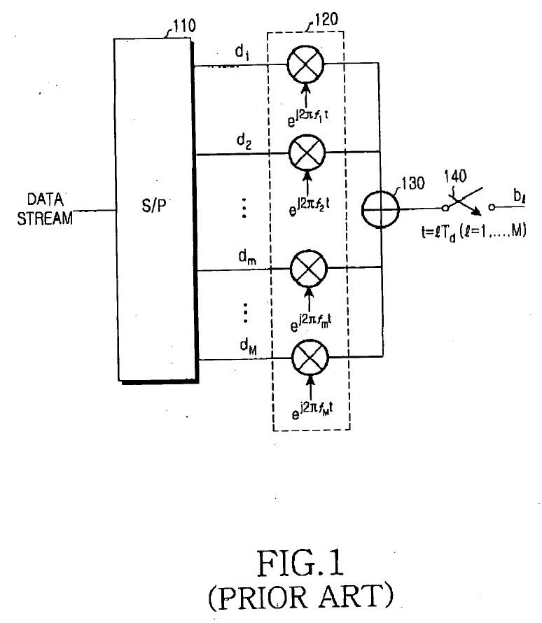

FIG. 1 illustrates a multicarrier modulator based on an operational principle of the OFDM communication system. Referring to FIG. 1, a serial-to-parallel (S/P) converter 110 converts a data stream formed by M consecutive data elements into M parallel data elements d₁, d₂, . . . , d_{M}, and inputs the M parallel data elements into a multiplier unit 120. The multiplier unit 120 includes M multipliers. The M multipliers modulate the parallel data elements using subcarriers f₁, f₂, . . . f_{M}. An adder 130 sums M modulated signals to generate an OFDM signal. A difference between the subcarriers f₁, f₂, . . . f_{M} is set to the inverse of a predetermined symbol time Tₛ. Accordingly, different subcarriers are orthogonal to each other, such that interference between the subcarriers can be avoided for one OFDM symbol time.

Because the OFDM signal is an analog signal, it is converted according to a digital scheme using Fast Fourier Transform (FFT). A switch 140 is used to sample the OFDM signal such that digital processing is performed. More specifically, the switch 140 is closed at each sample time T_{d}, in order to sample the OFDM signal. At each sample time T_{d}, an OFDM sample bₗ (where l=1, . . . , M) is output.

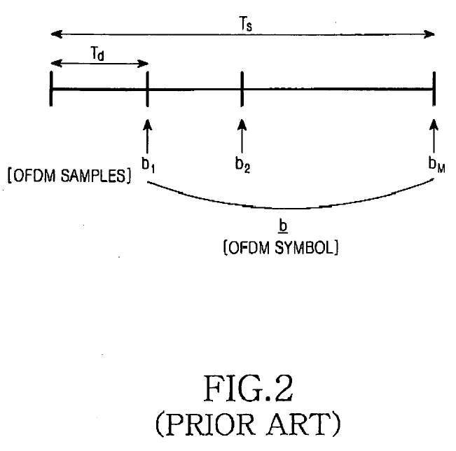

FIG. 2 illustrates a relation between OFDM samples and an OFDM symbol.

As illustrated in FIG. 2, an OFDM symbol time Tₛ is a time interval of receiving M new data samples from the S/P converter 110 of FIG. 1. The sample time T_{d} is an OFDM sample time.

Because a channel of a single path does not use a cyclic prefix (CP) inserted into each symbol to prevent inter-symbol interference (ISI), the OFDM symbol time Tₛ becomes M times the OFDM sample time T_{d}. When the CP is used, the OFDM symbol time Tₛ becomes (M+CP) times the OFDM sample time T_{d}. The (M+CP) value is a sum of the number of M data samples and the number of CP samples. Consequently, the OFDM samples output during one OFDM symbol time Tₛ form one OFDM symbol. That is, the one OFDM symbol is formed by (M+CP) number of OFDM samples.

Herein, an index of an OFDM symbol time is denoted by the subscript/superscript n, an index of a sample time is denoted by the subscript/superscript l, and an index of a subcarrier is denoted by the subscript/superscript m. Accordingly, t_{n,l} representing the l-th sample time of the n-th symbol is expressed by Equation (1). An OFDM sample signal b₍ₙ₎(t_{n,l)} in the time t_{n,l} is expressed by Equation (2).
t_{n,l}=(n−1)Tₛ+(l−1)T_{d} (1)

$$\begin{matrix}{b}^{( n )} ( {t}_{n , l} ) = \frac{1}{\sqrt{M}} {\sum }_{m = 1}^{M} {\underline{d}}_{m}^{( n )} \cdot exp \{ j 2 π \frac{m - 1}{{T}_{s}} {t}_{n , l} \} \\ = \frac{1}{\sqrt{M}} {\sum }_{m = 1}^{M} {\underline{d}}_{m}^{( n )} \cdot exp \{ j 2 π \frac{( l - 1 )}{M} \cdot ( m - 1 ) \}\end{matrix} \qquad ( 2 )$$

In Equation (2), dₘ⁽ⁿ⁾ is input data transmitted through the m-th subcarrier in the n-th OFDM symbol, and the underline “ ” denotes a vector formed by a plurality of data elements of the input data. The second right term of Equation (2) is obtained when Equation (1) is inserted into the first right term of Equation (2). The multiplication of the data part dₘ⁽ⁿ⁾ and the exponential part in Equation (2) is made as output of the multiplier unit 120 of FIG. 1.

Assuming that M OFDM sample signals form an OFDM symbol vector b, and M input data elements form a vector d, relations between the vectors are simply expressed by vector signal models of Equations (3) to (5).
b⁽ⁿ⁾=Dd⁽ⁿ⁾ (3)

$$\begin{matrix}\underline{D} = \frac{1}{\sqrt{M}} ( \begin{matrix}1 & 1 & ⋯ & 1 \\ 1 & exp \{ j 2 π \cdot \frac{1}{M} \cdot 1 \} & ⋯ & exp \{ j 2 π \cdot \frac{1}{M} \cdot ( M - 1 ) \} \\ ⋮ & ⋮ & ⋰ & ⋮ \\ 1 & exp \{ j 2 π \cdot \frac{M - 1}{M} \cdot 1 \} & ⋯ & exp \{ j 2 π \cdot \frac{M - 1}{M} \cdot ( M - 1 ) \}\end{matrix} ) \\ {[ \underline{D} ]}_{l , m} = \frac{1}{\sqrt{M}} exp \{ j 2 π \cdot \frac{( l - 1 )}{M} \cdot ( m - 1 ) \}\end{matrix} \qquad ( 4 )$$

d⁽ⁿ⁾=d₁⁽ⁿ⁾,d₂⁽ⁿ⁾, d_{M}⁽ⁿ⁾)^{T} (5)

In Equation (5), the superscript T denotes the transpose of a matrix.

In the multicarrier modulation matrix D defined in Equation (4), each row is associated with sample times, and each column is associated with subchannels (data). In multicarrier modulation, phases differ according to values of exponential functions in elements of the matrix D. In each of the exponential functions in the matrix elements of Equation (4), the front part is a phase variation value with respect to time, and the rear part is a phase variation value with respect to a subcarrier.

Herein, the term “subchannel” indicates a conceptual channel for transmitting a subdata stream when a data stream input to the OFDM transmitter is converted into M subdata streams by the S/P converter 110 of FIG. 1. The term “subcarrier” indicates a transmission frequency band mapped to the subchannel to be transmitted through a radio channel. The subchannel and subcarrier have an index in the range of 1 to M, respectively, and are mapped to each other according to a one-to-one correspondence.

A mapping relation between the subchannel data and the subcarrier frequency for the multicarrier modulation in the conventional OFDM system will be mathematically described with reference to an element (1, m) of the matrix D defined in Equation (4). In all rows of the matrix, a value (l−1)(m−1) is multiplied in a phase modulation part of the m-th column regardless of a sample time index 1. That is, during all the sample times within one symbol, the m-th subchannel data is modulated into a frequency of the m-th subcarrier, and a result of the modulation is transmitted.

In the OFDM communication system, a multicarrier modulation process illustrated in FIG. (1) is implemented with Inverse Fast Fourier Transform (IFFT), and a multicarrier demodulation process is implemented with Fast Fourier Transform (FFT). The transmitter and receiver of the OFDM system will be described with reference to the above-described signal models.

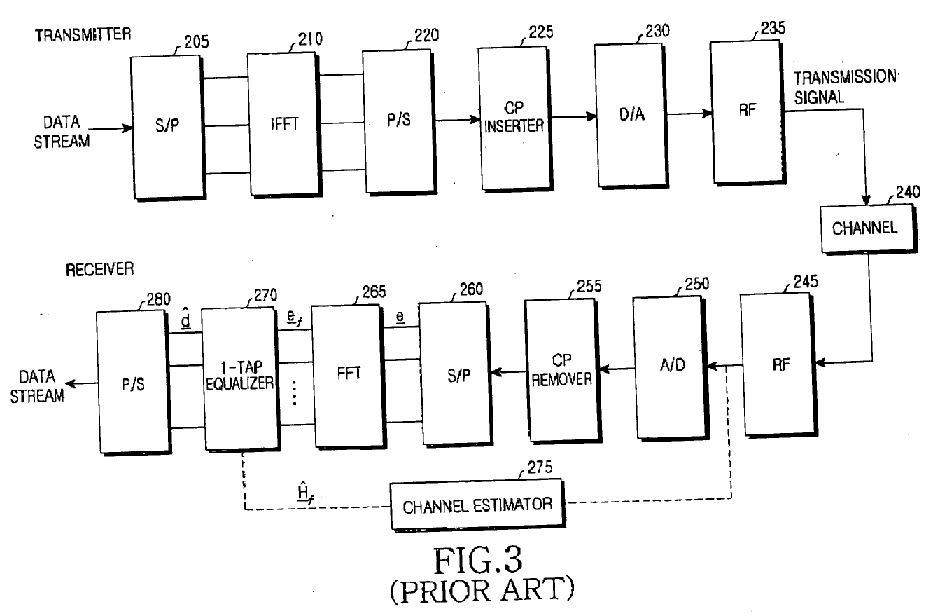

FIG. 3 is a block diagram illustrating the conventional transmitter and receiver of the OFDM communication system. Referring to FIG. 3, an S/P converter 205 converts a data stream formed by M consecutive data elements into parallel data \overline{d}, and outputs the parallel data elements to an IFFT processor 210. The IFFT processor 210 transforms the parallel data of the frequency domain into time domain signals forming a transmission signal b. The time domain signals are defined by Equation (3).

A parallel-to-serial (P/S) converter 220 converts the time domain signals output from the IFFT processor 210. A result of the conversion is input to a cyclic prefix (CP) inserter 225. The CP inserter 225 inserts a CP for removing ISI in a multipath channel. That is, the CP inserter 225 inserts the CP corresponding to a repeat of the last part of the transmission signal b, and outputs a result of the insertion. A digital-to-analog (D/A) converter 230 converts an output signal of the CP inserter 225 into an analog signal. A radio frequency (RF) unit 235 converts the analog signal into an RF signal, and then transmits the RF signal through a transmit antenna.

The signal transmitted through the transmit antenna is input to a receive antenna through a multipath channel 240 between transmitting and receiving terminals. The channel 240 is modeled into a channel matrix Hₜ representing channel characteristics in the time domain and a white noise signal n, in the receiving terminal.

In the receiver, an RF unit 245 converts the signal received by the receive antenna through the multipath channel 240 into a baseband signal. An analog-to-digital (A/D) converter 250 converts the baseband signal into a digital signal. A CP remover 255 removes a CP from the digital signal output from the A/D converter 250. The CP for removing ISI in the multipath channel 240 is used to establish the signal periodicity in the mathematical signal model of the OFDM system based on FFT/IFFT. Accordingly, the CP is not taken into account in the following signal model in which the signal periodicity has been established. In the following signal model, a transmission signal vector is referred to as “b” denoting output of the IFFT processor 210, and a received signal vector is referred to as “e” denoting output of the S/P converter 260 after output of the CP remover 255 is converted. The received signal vector e is expressed by Equation (6).
e=H,b+n, (6)

An FFT processor 265 performs a multicarrier demodulation function opposite to that of the IFFT processor 210 of the transmitting terminal. The FFT processor 265 transforms the received signal vector e into a frequency domain signal e_{f} as shown in Equation (7).
e_{f}=D^{H}Hₜb+D^{H}nₜ=D^{H}HₜDD^{H}b+n_{f}=H_{f}d+n_{f} (7)

In Equation (7), a time domain channel matrix Hₜ and a frequency domain channel matrix H_{f} are associated with singular value decomposition (SVD), i.e., H_{f}=D^{H}HₜD. When subcarriers are orthogonal to each other, the frequency domain channel matrix H_{f} is a diagonal matrix. Because the frequency domain signal e_{f} of Equation (7) is expressed in the form of multiplying data of each subcarrier by a channel gain associated with each subcarrier and a phase variation value associated with each symbol, data can be demodulated only by division.

The output signal e_{f} of the FFT processor 265 is input to a 1-tap equalizer 270. A channel estimator 275 estimates element values of the frequency domain channel matrix H_{f}, i.e., channel gain values, from the signal received by the RF unit 245, and then provides the 1-tap equalizer 270 with the estimated channel gain values. The 1-tap equalizer 270 multiplies the output signal e_{f} of the FFT processor 265 by an inverse channel matrix Ĥ_{f}⁻¹ using the channel gain values. Because the frequency domain channel matrix H_{f} is the diagonal matrix, the multiplication of the inverse matrix of the diagonal matrix is the same as a result obtained by dividing the channel matrix by subcarrier-by-subcarrier channel gains. If the channel estimator 275 has accurately performed estimation, Ĥ_{f}⁻¹H_{f}=I_{M}, where l is the identity matrix. Output of the 1-tap equalizer 270 is an estimated data signal vector \hat{\hat{d}}, and is finally output as an estimated data stream through the P/S converter 280.

In the transmitter and receiver of the OFDM communication system illustrated in FIG. 3, subchannel data output from the IFFT processor 210 is transmitted through fixed subcarriers. The OFDM communication system supporting frequency hopping (FH) hops to a different subcarrier on the basis of a single OFDM sample time or a multiple of an OFDM sample time. When the FH is used, an M*M switch is additionally arranged between the S/P converter 110 and the multiplier unit 120 of the multicarrier modulator illustrated in FIG. 1 to couple M inputs to M outputs according to a predetermined FH pattern.

In a fast frequency hopping (FFH) scheme in accordance with a preferred embodiment of the present invention, a time interval of hopping to a subcarrier for one subchannel is the single OFDM sample time or the multiple of the OFDM sample time. Herein, FH capable of being performed at each OFDM sample time will be described for the convenience of explanation. A mapping connection of the M*M switch is changed at each sample time during one symbol signal time. When each subchannel is mapped to a different subcarrier at each sample time in the FFH scheme, an OFDM sample signal vector is referred to as b_{H}. Here, the subscript H denotes FFH.

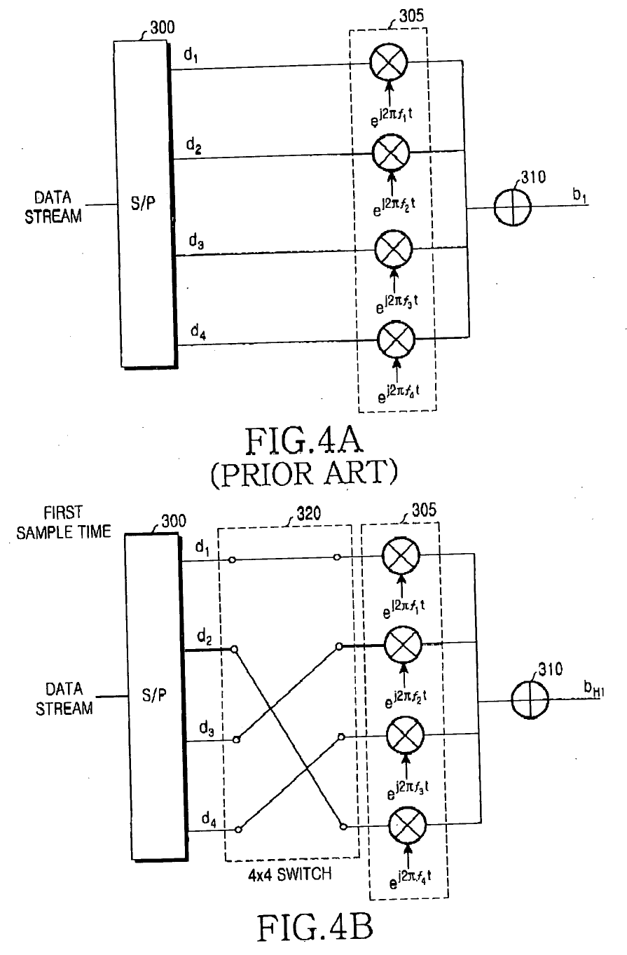

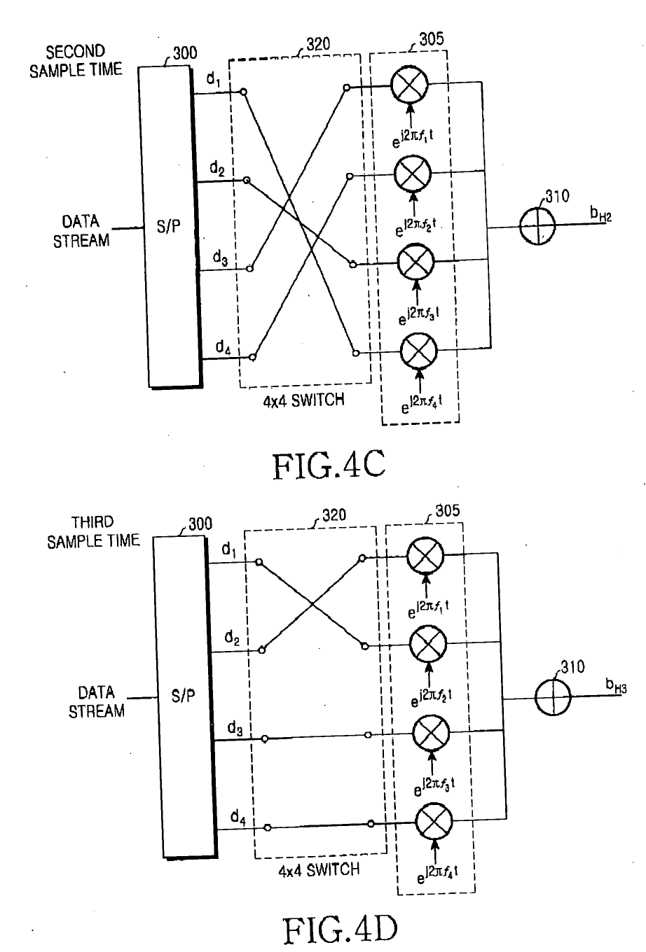

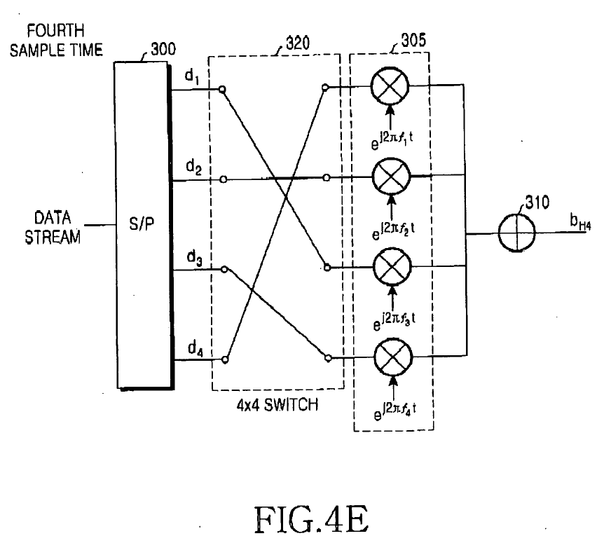

FIG. 4A is a schematic diagram illustrating an example in which a multicarrier modulator does not use FH, where M=4. As illustrated in FIG. 4A, an S/P converter 300 converts a data stream into four data elements d₁, d₂, d₃, and d₄, which form a data vector d, and then outputs the four data elements to four subchannels. The four data elements d₁, d₂, d₃, and d₄ are input to corresponding multipliers of a multiplier unit 305, and are modulated into corresponding subcarriers. An adder 310 sums the subcarriers, and outputs a transmission signal vector b. In this case, the four data elements are transmitted through fixed subcarriers during one symbol time.

FIGS. 4B to 4E are schematic diagrams illustrating examples of multicarrier modulators using FH, where M=4, in accordance with preferred embodiments of the present invention. As illustrated in FIGS. 4B to 4E, a 4*4 switch is additionally arranged between the S/P converter 300 and the multiplier unit 305, and maps four inputs to four outputs according to a different FH pattern at each sample time.

FIG. 4B illustrates a switching process in the first sample time. The first, second, third, and fourth subchannels are mapped to the first, fourth, second, and third subcarriers, respectively.

FIG. 4C illustrates a switching process in the second sample time. The first, second, third, and fourth subchannels are mapped to the fourth, third, first, and second subcarriers, respectively.

FIG. 4D illustrates a switching process in the third sample time. The first, second, third, and fourth subchannels are mapped to the second, first, third, and fourth subcarriers, respectively.

FIG. 4E illustrates a switching process in the fourth sample time. The first, second, third, and fourth subchannels are mapped to the third, second, fourth, and first subcarriers, respectively. The above-mentioned sample times have different hopping patterns for subcarriers.

Subcarriers mapped to the first subchannel are [1 4 2 3] in order of time. Subcarriers mapped to the second subchannel are [4 3 1 2] in order of time. Subcarriers mapped to the third subchannel are [2 1 3 4] in order of time. Subcarriers mapped to the fourth subchannel are [3 2 4 1] in order of time. [1 4 2 3], [4 3 1 2], [2 1 3 4], or [3 2 4 1] is a hopping pattern for each subchannel.

Because a data signal d₁ of the first subchannel is fixedly modulated into the first subcarrier within one OFDM symbol even when a channel state of the first subchannel is bad in FIG. 4A, an error occurs. In the multicarrier modulators of FIGS. 4B to 4E, the data signal d₁ of the first subchannel is transmitted through FH of all subcarriers in order of [1 4 2 3] at the respective sample times, such that the probability of successfully recovering transmitted data in a receiving terminal is improved because of the frequency diversity effect even when the channel state of the first subcarrier is bad. Similarly, data signals d₂, d₃, and d₄ of other subchannels hop to all subcarriers, i.e., all bands, within one OFDM symbol time. Accordingly, even when any one subcarrier suffers deep fading, the receiving terminal can recover original data.

To obtain the frequency diversity effect through FH in a symbol time unit, the conventional system requires many OFDM symbol durations, and a required time increases in proportion to an FFT size. However, the FFH scheme of the present invention, which is capable of performing FH at each OFDM sample time, can be added to the conventional FH of the symbol time unit in the OFDM system, and can improve the overall performance of the entire system owing to the frequency diversity effect.

Hereinafter, a signal model of the OFDM system using the FFH scheme in accordance with a preferred embodiment of the present invention will be described.

A hopping pattern matrix Φ with an element (l, m) based on an index of a subcarrier mapped to the m-th subchannel in the l-th sample time is defined by Equation (8).

$$Φ = [ \begin{matrix}{[ Φ ]}_{1 , 1} & {[ Φ ]}_{1 , 2} & ⋯ & {[ Φ ]}_{1 , M} \\ {[ Φ ]}_{2 , 1} & {[ Φ ]}_{2 , 2} & ⋯ & {[ Φ ]}_{2 , M} \\ ⋮ & ⋮ & ⋰ & ⋮ \\ {[ Φ ]}_{M , 1} & {[ Φ ]}_{M , 2} & ⋯ & {[ Φ ]}_{M , M}\end{matrix} ] , {[ Φ ]}_{l . m} = 0 , … , M - 1 \\ ( l , m = 1 , … , M ) \qquad ( 8 )$$

In the hopping pattern matrix, each row indicates subcarriers mapped to all subchannels in one sample time, and each column indicates subcarriers mapped to one subchannel in all sample times of one symbol. When multicarrier modulation is performed according to the hopping pattern matrix of Equation (8), the relation between data and an OFDM symbol vector is expressed by Equation (9) and a matrix D_{H} for multicarrier modulation concluding FH is expressed by Equation (10).
b_{H}⁽ⁿ⁾=D_{H}d⁽ⁿ⁾ (9)

$$\begin{matrix}{\underline{D}}_{H} = \frac{1}{\sqrt{M}} ( \begin{matrix}1 & 1 & ⋯ & 1 \\ exp \{ j 2 π \cdot \frac{1}{M} \cdot {[ Φ ]}_{2 , 1} \} & exp \{ j 2 π \cdot \frac{1}{M} \cdot {[ Φ ]}_{2 , 2} \} & ⋯ & exp \{ j 2 π \cdot \frac{1}{M} \cdot {[ Φ ]}_{2 , M} \} \\ ⋮ & ⋮ & ⋰ & ⋮ \\ exp \{ j 2 π \cdot \frac{M - 1}{M} \cdot {[ Φ ]}_{M , 1} \} & exp \{ j 2 π \cdot \frac{M - 1}{M} \cdot {[ Φ ]}_{M , 2} \} & ⋯ & exp \{ j 2 π \cdot \frac{M - 1}{M} \cdot {[ Φ ]}_{M , M} \}\end{matrix} ) \\ {[ {\underline{D}}_{H} ]}_{l , m} = \frac{1}{\sqrt{M}} exp \{ j 2 π \cdot \frac{l - 1}{M} \cdot {[ Φ ]}_{l . m} \}\end{matrix} \qquad ( 10 )$$

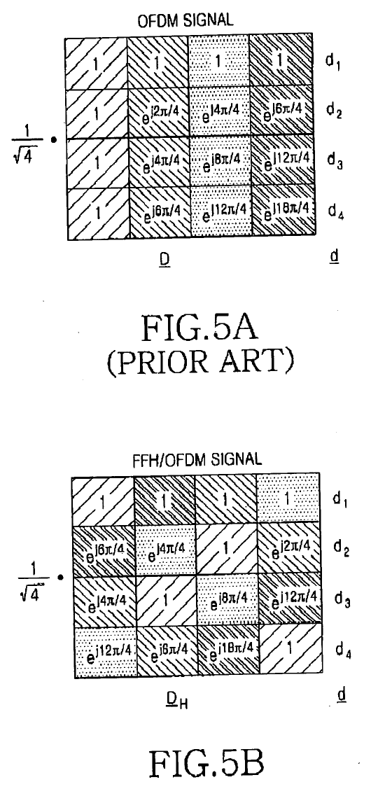

FIGS. 5A and 5B are conceptual diagrams illustrating vector signal models representing multicarrier modulation in an OFDM system and an FFH/OFDM system. FIGS. 5A and 5B are associated with the 4*4 model illustrated in FIGS. 4A to 4E.

Referring to FIG. 5A, a hopping pattern in the FFH scheme is the same as the example of FIG. 4A described above. FIG. 5B illustrates a vector computation for performing multicarrier modulation on data according to Equation (10). In FIGS. 5A and 5B, one rectangle is one matrix element, and a value within each rectangle is a corresponding element value.

Because FIG. 5A illustrates an OFDM signal after multicarrier modulation in a basic OFDM system, a hopping pattern for all rows of FIG. 5A is based on Equation (11) as in the matrix of Equation (4). That is, because subcarriers mapped to a specific subchannel are equal in all sample times, subcarriers mapped to each subchannel are equal regardless of a sample time index l.
[Φ]_{l,m}=m−1 for l=1, . . . , M (11)

FIG. 5B illustrates an FFH/OFDM signal in accordance with a preferred embodiment of the present invention. As illustrated in FIGS. 4B to 4E, each subchannel is mapped to a different subcarrier at each sample time. When hopping patterns of the examples of FIGS. 4B to 4E are used, a multicarrier modulation matrix is expressed by Equation (12).

$${\underline{D}}_{H} = \frac{1}{\sqrt{4}} ( \begin{matrix}exp \{ j 2 π \cdot \frac{0}{4} \cdot 0 \} & exp \{ j 2 π \cdot \frac{0}{4} \cdot 3 \} & exp \{ j 2 π \cdot \frac{0}{4} \cdot 1 \} & exp \{ j 2 π \cdot \frac{0}{4} \cdot 2 \} \\ exp \{ j 2 π \cdot \frac{1}{4} \cdot 3 \} & exp \{ j 2 π \cdot \frac{1}{4} \cdot 2 \} & exp \{ j 2 π \cdot \frac{1}{4} \cdot 0 \} & exp \{ j 2 π \cdot \frac{1}{4} \cdot 1 \} \\ exp \{ j 2 π \cdot \frac{2}{4} \cdot 1 \} & exp \{ j 2 π \cdot \frac{2}{4} \cdot 0 \} & exp \{ j 2 π \cdot \frac{2}{4} \cdot 2 \} & exp \{ j 2 π \cdot \frac{2}{4} \cdot 3 \} \\ exp \{ j 2 π \cdot \frac{3}{4} \cdot 2 \} & exp \{ j 2 π \cdot \frac{3}{4} \cdot 1 \} & exp \{ j 2 π \cdot \frac{3}{4} \cdot 3 \} & exp \{ j 2 π \cdot \frac{3}{4} \cdot 0 \}\end{matrix} ) \qquad ( 12 )$$

The 4*4 switch is basically used to perform a switching operation at each sample time as illustrated in FIGS. 4B to 4E, such that the multicarrier modulation matrix D_{H} is computed in the OFDM system using the FFH scheme in accordance with the present invention. In this case, implementation complexity is high and also a control operation is not easy, such that extension is impossible.

Accordingly, the present invention proposes a transmitter and receiver using a FFH frequency modulator for the multicarrier modulation based on the FFH scheme. The FFH frequency Modulator may comprise a linear processor and an Inverse Fast Fourier Transform (IFFT) processor. Two types of transmitters in accordance with preferred embodiments of the present invention will be described in detail.

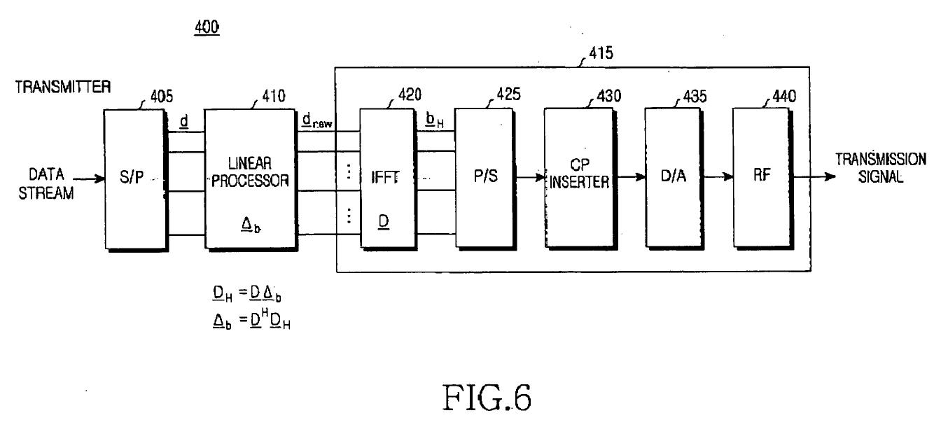

FIG. 6 is a block diagram illustrating a transmitter 400 of an FFH/OFDM communication system in accordance with a preferred embodiment of the present invention. An IFFT processor 420, a P/S converter 425, a CP inserter 430, a D/A converter 435, and an RF unit 440 form an OFDM transmitter 415. In accordance with the present invention, a linear processor 410 processes FFH.

Referring to FIG. 6, an S/P converter 405 converts a data stream input to the transmitter 400 into a vector d of M data elements corresponding to M subchannels in a parallel fashion. The S/P converter 405 inputs the vector into a linear processor 410. The linear processor 410 couples data elements input in sample times to subcarriers according to a hopping pattern of subchannels. A data vector after FH of the linear processor 410 is denoted by d_{new}. The IFFT processor 420 transforms the data vector output from the linear processor 410 into a time domain signal b_{H} after FH. When a transformation matrix of the linear processor 410 is Δ_{b}, an FH/multicarrier modulation matrix D_{H} associated with the linear processor 410 and the IFFT processor 420 can be expressed as shown Equation (13).
D_{H}=DD^{H}D_{H}=DΔ_{b}
DD^{H}=I (13)
Δ_{b}=D^{H}D_{H} (13)

In Equation (13), the superscript H denotes a Hermitian transformation of matrix.

The P/S converter 425 converts the transmission signal vector b_{H} after FH output from the IFFT processor 420 in a serial fashion, and then inputs the serial transmission signal into the CP inserter 430. The CP inserter 430 is selectively used. The CP inserter 430 inserts a CP corresponding to a repeat of the last part of the transmission signal output from the P/S converter 425. The transmission signal into which the CP has been inserted is output. The D/A converter 435 converts an output signal of the CP inserter 430 into an analog signal. The RF unit 440 converts the analog signal into an RF signal and then transmits the RF signal through a transmit antenna.

The linear processor 410 of the transmitter 400 of FIG. 6 generates a new data vector d_{new} associated with all subcarriers from an input data vector d according to FH patterns. The IFFT processor 420 receives data [d_{new}]ₘ generated by linearly combining all data elements with the m-th subchannel in the frequency domain, and maps the data [d_{new}]ₘ to the m-th subcarrier.

d_{new} is a vector generated by linearly combining data elements of the data vector d. For example, when it is assumed that the data vector based on a 2*1 matrix is

$$[ \begin{matrix}{d}_{1} \\ {d}_{2}\end{matrix} ]$$

and a transmission matrix of the linear processor 410 is a 2*2 matrix of

$$[ \begin{matrix}1 & 1 \\ 1 & - 1\end{matrix} ] ,$$

a new data vector d_{new} output from the linear processor 410 becomes

$$[ \begin{matrix}1 * {d}_{1} + 1 * {d}_{2} \\ 1 * {d}_{1} - 1 * {d}_{2}\end{matrix} ] .$$

That is, each element of d_{new} is associated with both data elements d₁ and d₂. As described above, the relation between d and d_{new} is easily expressed by a matrix.

If the data vector d is input to the IFFT processor 420, the first data element d₁ is transmitted through the first subchannel in a frequency band, and the second data element d₂ is transmitted through the second subchannel in a frequency band. Accordingly, each data element independently passes through a single channel. However, when d_{new} output from the linear processor 410 is input to the IFFT processor 420, the first element d₁+d₂ of d_{new} is transmitted through the first subchannel, and the second element d₁−d₂ of d_{new} is transmitted through the second subchannel. Consequently, both the data elements d₁ and d₂ are transmitted through the two subchannels.

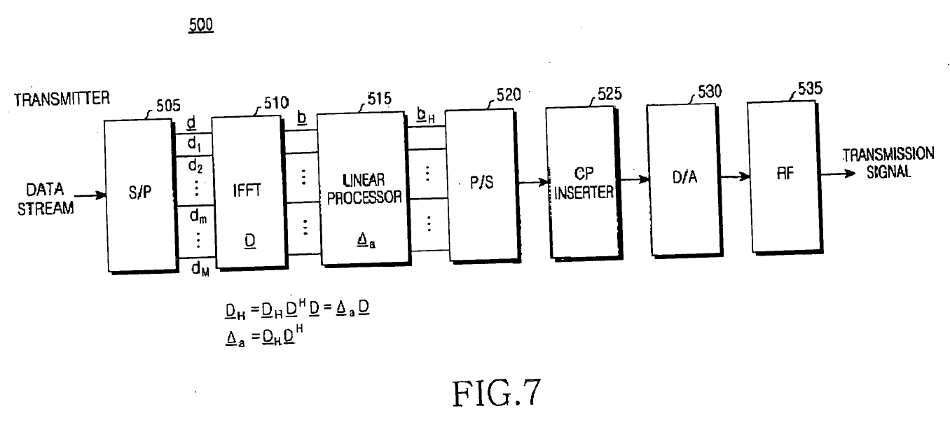

FIG. 7 is a block diagram illustrating a transmitter 500 of an FFH/OFDM communication system in accordance with another preferred embodiment of the present invention. Referring to FIG. 7, an S/P converter 505 converts a data stream input to the transmitter 500 into a vector d of M data elements corresponding to M subchannels in a parallel fashion. The S/P converter 505 inputs the vector to an IFFT processor 510. The IFFT processor 510 transforms input data elements into a time domain transmission signal b, and then transfers the time domain transmission signal b to a linear processor 515. The linear processor 515 transforms the transmission signal b into a time domain signal b_{H} after FH. When a transformation matrix of the linear processor 515 is denoted by Δₐ, an FH/multicarrier modulation matrix D_{H} can be expressed as shown in Equation (14).
D_{H}=D_{H}D^{H}D=ΔₐD
DD^{H}=I
Δ=D_{H}D^{H} (14)

A P/S converter 520 converts the transmission signal vector b_{H} after FH output from the linear processor 515 in a serial fashion, and then inputs the serial transmission signal to a CP inserter 525. The CP inserter 525 is selectively used. The CP inserter 525 inserts a CP corresponding to a repeat of the last part of the transmission signal output from the P/S converter 520. The transmission signal into which the CP has been inserted is then output. A D/A converter 530 converts an output signal of the CP inserter 525 into an analog signal. An RF unit 535 converts the analog signal into an RF signal and then transmits the RF signal through a transmit antenna.

The transmitter of the FFH/OFDM system illustrated in FIG. 6 or 7 is implemented by adding the linear processor defined by Equation (13) or (14) to the basic OFDM transmitter. In the two embodiments, a transmission OFDM symbol vector is expressed by Equation (9).

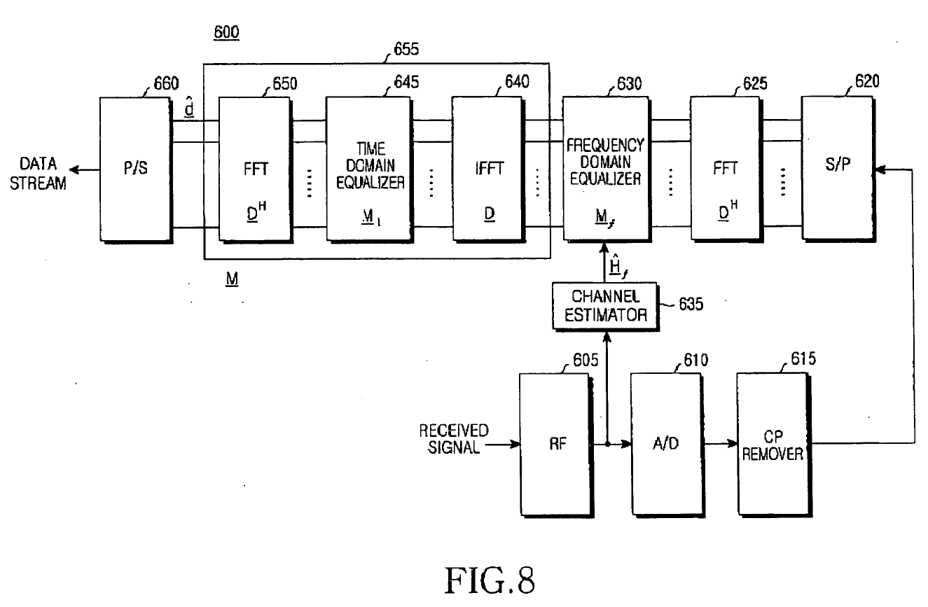

FIG. 8 is a block diagram illustrating a receiver 600 of an FFH/OFDM communication system in accordance with a preferred embodiment of the present invention. Referring to FIG. 8, an RF unit 605 converts a multipath channel signal received through a receive antenna into a baseband signal. An A/D converter 610 converts the baseband signal into a digital signal. A CP remover 615 removes a CP from the digital signal. A signal e_{H} output from the CP remover 615 is expressed by Equation (15).
e_{H}=Hₜb_{H}+nₜ (15)

An S/P converter 620 converts the signal e_{H} in a parallel fashion, and inputs the converted signal to an FFT processor 625. The FFT processor 625 outputs a frequency domain signal e_{Hf} as shown in Equation (16).
e=_{Hf}D^{H}Hₜb_{H}+D^{H}nₜ=H_{f}Ad+n_{f}
A=D^{H}ΔₐD=Δ_{b},Hₜ=DH_{f}D^{H} (16)

The matrix A is used for a transformation in the receiver 600 for FFH in accordance with the present invention. It can be seen that the matrix Δ_{b} or Δₐ of Equation (16) is the same as the matrix Δ_{b} or Δₐ used in the transmitter of FIG. 6 or 7.

The method for easily estimating a transmitted data stream multiplies the signal e_{Hf} of Equation (16) by the inverse matrix of a transformation matrix of the transmitter. As seen in Equations (17) and (18), the inverse matrix is formed by an equalization matrix of the frequency domain defined by M_{f}, an equalization matrix of the time domain defined by Mₜ, and IFFT/FFT matrices D and D^{H}. In this case, the remaining part M, except the equalization matrix M_{f}, of the frequency domain for recovering channel characteristics is a recovery matrix associated with the FH/multicarrier modulation.

$${( {\underline{H}}_{f} \underline{A} )}^{- 1} = {( {\underline{H}}_{f} {\underline{D}}^{H} {\underline{Δ}}_{a} \underline{D} )}^{- 1} = \underbrace{{\underline{D}}^{H} \underbrace{{\underline{Δ}}_{a}^{H}}_{= {\underline{M}}_{t}}} \underline{D} \underbrace{{\underline{H}}_{f}^{- 1}}_{{\underline{M}}_{f}} \qquad ( 17 )$$

Δₐ⁻¹=Δₐ^{H},D⁻¹=D^{H} (18)

The output signal e_{Hf} of the FFT processor 625 is input to a 1-tap equalizer 630 of the frequency domain (hereinafter, referred to as the frequency domain equalizer). A channel estimator 635 estimates element values of the channel matrix H_{f} of the frequency domain, that is, channel gain values, from a signal received by the RF unit 605, and then outputs the estimated values to the frequency domain equalizer 630. The frequency domain equalizer 630 multiplies the frequency domain signal e_{Hf} by the equalization matrix M_{f} of the frequency domain defined by Equation (17).

Output of the frequency domain equalizer 630 is input to an IFFT processor 640. The IFFT processor 640 provides an equalizer 645 of the time domain (hereinafter, referred to as the time domain equalizer) with a result obtained by multiplying the output of the frequency domain equalizer 630 by an IFFT matrix D. The time domain equalizer 645 provides an FFT processor 650 with a result obtained by multiplying output of the IFFT processor 640 by the equalization matrix Mₜ of the time domain defined by Equation (17). Output of the FFT processor 650 is an estimation data vector \hat{d}, and is finally output as an estimated data stream through a P/S converter 660.

The IFFT processor 640, the time domain equalizer 645, and the FFT processor 650 form an FH recovery unit 655 for recovering an original data stream by multiplying a time domain signal after FH by the matrix M defined in Equation (17). It can be seen from Equation (16) that D^{H}Δₐ^{H}D=Δ_{b}⁻¹. Accordingly, the FH recovery unit 655 performs the inverse transformation of the transformation performed by the linear processor 410 of FIG. 6. The time domain equalizer 645 performs the inverse transformation of the transformation performed by the linear processor 515 of FIG. 7.

The FH recovery unit 655 configured by three components has been described above. Alternatively, the FH recovery unit 655 may be configured by one entity that is capable of multiplying data by the matrix M in accordance with another preferred embodiment of the present invention.

As is apparent from the above description, the present invention has a number of inventive effects.

For example, the present invention enables an orthogonal frequency division multiplexing (OFDM) subchannel to hop from one subcarrier to another on the basis of a multiple of an OFDM sample time, thereby improving the probability of successfully recovering transmitted data in a receiving terminal owing to the frequency diversity effect, even when the channel state of the first subcarrier is bad. Because data of one subchannel is hopped to all subcarriers, that is, all frequency bands, within one OFDM symbol time, a receiving terminal can recover data even when any one subcarrier suffers deep fading. The fast frequency hopping (FFH) scheme of the present invention is not limited to a hopping time of an OFDM system, and can improve the performance of the entire system because of the frequency diversity effect.

Although preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

1. A transmitter for performing fast frequency hopping (FFH) in an orthogonal frequency division multiplexing (OFDM) communication system using a plurality of subcarriers, comprising:
a serial-to-parallel (S/P) converter for converting an input data stream into a data vector having a plurality of data elements;
an FFH frequency modulator for converting the data elements of the data vector into a transmission signal vector that hops to a frequency in a sample time unit, according to an FFH pattern of the sample time unit; and
a parallel-to-serial (P/S) converter for converting the transmission signal vector in a serial fashion to output a transmission signal.

2. The transmitter according to claim 1, wherein the FFH frequency modulator comprises:
a linear processor for transforming the data elements of the data vector into a new data vector according to the FFH pattern of the sample time unit, and outputting the new data vector; and
an Inverse Fast Fourier Transform (IFFT) processor for transforming the new data vector by using IFFT to output the transmission signal vector formed by a plurality of samples.

3. The transmitter according to claim 2, wherein the linear processor outputs the new data vector using:
d_{new}=D^{H}D_{H}d,
where d denotes the data vector, d_{new} denotes the new data vector, D_{H} denotes a frequency hopping and multicarrier modulation matrix according to the FFH pattern, and D^{H} denotes an inverse matrix of an IFFT matrix.

4. The transmitter according to claim 3, wherein the frequency hopping and multicarrier modulation matrix is defined by:
$$\begin{matrix}{\underline{D}}_{H} = \frac{1}{\sqrt{M}} ( \begin{matrix}1 & 1 & ⋯ & 1 \\ exp \{ j 2 π \cdot \frac{1}{M} \cdot {[ Φ ]}_{2 , 1} \} & exp \{ j 2 π \cdot \frac{1}{M} \cdot {[ Φ ]}_{2 , 2} \} & ⋯ & exp \{ j 2 π \cdot \frac{1}{M} \cdot {[ Φ ]}_{2 , M} \} \\ ⋮ & ⋮ & ⋰ & ⋮ \\ exp \{ j 2 π \cdot \frac{M - 1}{M} \cdot {[ Φ ]}_{M , 1} \} & exp \{ j 2 π \cdot \frac{M - 1}{M} \cdot {[ Φ ]}_{M , 2} \} & ⋯ & exp \{ j 2 π \cdot \frac{M - 1}{M} \cdot {[ Φ ]}_{M , M} \}\end{matrix} ) , and \\ {[ {\underline{D}}_{H} ]}_{l , m} = \frac{1}{\sqrt{M}} exp \{ j 2 π \cdot \frac{l - 1}{M} \cdot {[ Φ ]}_{l , m} \} ,\end{matrix}$$
where M denotes the number of subcarriers, [Φ]_{l,m} denotes an index of a subcarrier mapped to an m-th data element in an l-th sample time, and [D_{H}]_{l,m} denotes an element of an m-th column of an l-th row in the frequency hopping and multicarrier modulation matrix.

5. The transmitter according to claim 1, wherein the FFH frequency modulator comprises:
an Inverse Fast Fourier Transform (IFFT) processor for transforming the data vector using IFFT to output the transmission signal vector formed by a plurality of samples; and
a linear processor for transforming data elements of the transmission signal vector according to the FFH pattern of the sample time unit, and outputting the transmission signal vector after frequency hopping.

6. The transmitter according to claim 5, wherein the linear processor outputs the transmission signal vector after frequency hopping by using:
b_{H}=D_{H}D^{H}b,
where b_{H} denotes the transmission signal vector after frequency hopping, b denotes the transmission vector before frequency hopping, D^{H} denotes an inverse matrix of an IFFT matrix, and D_{H} denotes a frequency hopping and multicarrier modulation matrix according to the FFH pattern.

7. The transmitter according to claim 6, wherein the frequency hopping and multicarrier modulation matrix is defined by:
$${\underline{D}}_{H} = \frac{1}{\sqrt{M}} ( \begin{matrix}1 & 1 & … & 1 \\ exp \{ j2π \cdot \frac{1}{M} \cdot {[ Φ ]}_{2 , 1} \} & exp \{ j2π \cdot \frac{1}{M} \cdot {[ Φ ]}_{2 , 2} \} & … & exp \{ j2π \cdot \frac{1}{M} \cdot {[ Φ ]}_{2 , M} \} \\ ⋮ & ⋮ & ⋰ & ⋮ \\ exp \{ j2π \cdot \frac{M - 1}{M} \cdot {[ Φ ]}_{M , 1} \} & exp \{ j2π \cdot \frac{M - 1}{M} \cdot {[ Φ ]}_{M , 2} \} & … & exp \{ j2π \cdot \frac{M - 1}{M} \cdot {[ Φ ]}_{M , M} \}\end{matrix} ) , \\ {and [ {\underline{D}}_{H} ]}_{l , m} = \frac{1}{\sqrt{M}} exp \{ j2π \cdot \frac{l - 1}{M} \cdot {[ Φ ]}_{l , m} \} ,$$
where M denotes the number of subcarriers, [Φ]_{l,m} denotes an index of a subcarrier mapped to an m-th data element in an l-th sample time, and [D_{H}]_{l,m} denotes an element of an m-th column of an l-th row in the frequency hopping and multicarrier modulation matrix.

8. The transmitter according to claim 1, wherein the FFH pattern represents subcarriers mapped to the data elements of the data vector for multiple sample times.

9. The transmitter according to claim 1, further comprising:
a cyclic prefix (CP) inserter for inserting a CP into the transmission signal vector, the CP being a repeat of a part of the transmission signal;
a digital-to-analog (D/A) converter for converting output of the CP inserter into an analog signal; and
a radio frequency (RF) unit for converting the analog signal into an RF signal.

10. A receiver for recovering transmitted data according to a fast frequency hopping (FFH) pattern of a sample time unit in an orthogonal frequency division multiplexing (OFDM) communication system using a plurality of subcarriers, comprising:
a serial-to-parallel (S/P) converter for receiving, from a transmitter, a signal hopped to a frequency according to the FFH pattern of the sample time unit, and converting the received signal into a first received signal vector having a plurality of data samples;
a first Fast Fourier Transform (FFT) processor for transforming the first received signal vector into a second received signal vector of a frequency domain using FFT;
a first equalizer for multiplying the received signal vector by an inverse matrix of a channel matrix representing characteristics of a channel from the transmitter to the receiver;
a frequency hopping recovery unit for outputting a received signal vector recovered from an output of the first equalizer according to the FFH pattern of the transmitter; and
a parallel-to-serial (P/S) converter for converting the recovered received signal vector in a serial fashion and outputting a data stream.

11. The receiver according to claim 10, wherein the frequency hopping recovery unit outputs the recovered received signal by multiplying the output of the first equalizer by a recovery matrix defined by:
M=(D^{H}(D_{H}D^{H})^{H}D),
where M denotes the recovery matrix, D^{H} denotes an inverse matrix of an FFT matrix, D_{H} denotes a frequency hopping and multicarrier modulation matrix according to the FFH pattern of the transmitter, and D denotes an Inverse Fast Fourier Transform (IFFT) matrix.

12. The receiver according to claim 11, wherein the frequency hopping and multicarrier modulation matrix is defined by:
$${\underline{D}}_{H} = \frac{1}{\sqrt{M}} ( \begin{matrix}1 & 1 & … & 1 \\ exp \{ j2π \cdot \frac{1}{M} \cdot {[ Φ ]}_{2 , 1} \} & exp \{ j2π \cdot \frac{1}{M} \cdot {[ Φ ]}_{2 , 2} \} & … & exp \{ j2π \cdot \frac{1}{M} \cdot {[ Φ ]}_{2 , M} \} \\ ⋮ & ⋮ & ⋰ & ⋮ \\ exp \{ j2π \cdot \frac{M - 1}{M} \cdot {[ Φ ]}_{M , 1} \} & exp \{ j2π \cdot \frac{M - 1}{M} \cdot {[ Φ ]}_{M , 2} \} & … & exp \{ j2π \cdot \frac{M - 1}{M} \cdot {[ Φ ]}_{M , M} \}\end{matrix} ) , \\ {and [ {\underline{D}}_{H} ]}_{l , m} = \frac{1}{\sqrt{M}} exp \{ j2π \cdot \frac{l - 1}{M} \cdot {[ Φ ]}_{l , m} \} ,$$
where M denotes a number of subcarriers, [Φ]_{l,m} denotes an index of a subcarrier mapped to an m-th data element in an l-th sample time, and [D_{H}]_{l,m} denotes an element of an m-th column of an l-th row in the frequency hopping and multicarrier modulation matrix.

13. The receiver according to claim 10, wherein the frequency hopping recovery unit comprises:
an Inverse Fast Fourier Transform (IFFT) processor for transforming the output of the first equalizer into the received signal vector of a time domain by using IFFT;
a second equalizer for multiplying an output of the IFFT processor by an equalization matrix of the time domain; and
a second IFFT processor for transforming an output of the second equalizer using FFT, and outputting the recovered received signal vector.

14. The receiver according to claim 13, wherein the equalization matrix of the time domain is expressed by:
Mₜ=(D_{H}D^{H})^{H},
where Mₜ denotes the equalization matrix of the time domain, D_{H} denotes a frequency hopping and multicarrier modulation matrix according to the FFH pattern of the transmitter, and D^{H} denotes an FFT matrix.

15. The receiver according to claim 14, wherein the frequency hopping and multicarrier modulation matrix is defined by:
$${\underline{D}}_{H} = \frac{1}{\sqrt{M}} ( \begin{matrix}1 & 1 & … & 1 \\ exp \{ j2π \cdot \frac{1}{M} \cdot {[ Φ ]}_{2 , 1} \} & exp \{ j2π \cdot \frac{1}{M} \cdot {[ Φ ]}_{2 , 2} \} & … & exp \{ j2π \cdot \frac{1}{M} \cdot {[ Φ ]}_{2 , M} \} \\ ⋮ & ⋮ & ⋰ & ⋮ \\ exp \{ j2π \cdot \frac{M - 1}{M} \cdot {[ Φ ]}_{M , 1} \} & exp \{ j2π \cdot \frac{M - 1}{M} \cdot {[ Φ ]}_{M , 2} \} & … & exp \{ j2π \cdot \frac{M - 1}{M} \cdot {[ Φ ]}_{M , M} \}\end{matrix} ) , \\ {and [ {\underline{D}}_{H} ]}_{l , m} = \frac{1}{\sqrt{M}} exp \{ j2π \cdot \frac{l - 1}{M} \cdot {[ Φ ]}_{l , m} \} ,$$
where M denotes a number of subcarriers, [Φ]_{l,m} denotes an index of a subcarrier mapped to an m-th data element in an l-th sample time, and [D_{H}]_{l,m} denotes an element of an m-th column of an l-th row in the frequency hopping and multicarrier modulation matrix.

16. The receiver according to claim 10, wherein the FFH pattern represents subcarriers mapped to the data elements of the data vector for multiple sample times.

17. The receiver according to claim 10, further comprising:
a radio frequency (RF) unit for receiving and converting an RF signal from the transmitter to output a baseband analog signal;
an analog-to-digital (A/D) converter for converting the analog signal into a digital signal; and
a cyclic prefix (CP) remover for removing a CP corresponding to part of the digital signal and outputting the received signal, after frequency hopping.
